(19) United States
(12) Patent Application Publication
(10) Pub. No.: US 2018/0254024 A1
(43) Pub. Date: Sep. 6, 2018

(54) MUTE FOR STRINGED INSTRUMENT

(71) Applicant: Korg U.S.A., Inc., Melville, NY (US)

(72) Inventor: Robert McDonald, Petaluma, CA (US)

(73) Assignee: Korg U.S.A., Inc., Melville, NY (US)

(21) Appl. No.: 15/489,241

(22) Filed: Apr. 17, 2017

Related U.S. Application Data
(60) Provisional application No. 62/466,149, filed on Mar. 2, 2017.

(51) Int. Cl. G10D 3/04

(52) U.S. Cl. CPC G10D 3/046

(57) ABSTRACT

A mute for a stringed instrument has a formed bar of metal, plastic or other suitable material, the ends of which are folded to allow the part to wrap around the outermost strings, for example, the high E and low E strings of a 6-stringed guitar, in such a way as to be held firmly in place by the tension of the strings, but allowing for quick installation and removal. The inner surface of the mute is lined with a suitable material such as rubber or felt that makes firm contact with each of the strings between the bridge saddle and the tailpiece, effectively stopping the strings between the bridge saddle and tailpiece from producing an audible sound or resonance. The mute eliminates or mitigates vibration of that portion of the strings that might otherwise be undesirably picked up, especially by a bridge pickup of a hybrid guitar.

### RELATED APPLICATION

This application is related to and claims priority from U.S. Provisional Application 62/466,149 filed on Mar. 2, 2017, the disclosure of which is incorporated herein by reference in its entirety.

### FIELD OF THE INVENTION

The present invention related to guitars and, more particularly, to a mute for use with a guitar to dampen or eliminate vibration.

### BACKGROUND

Stringed musical instruments typically generate sounds of specific pitches by the vibration of stretched strings. In one common arrangement, which is used, for example in guitars, several strings, side by side, are stretched from an anchor near a tail of the guitar body, over a bridge that supports the strings, and up along a fretted neck to an attachment at the head with a device for adjusting the tension of each string. By holding a string down onto one of the frets, a player defines the length of string between the bridge and the chosen fret, and thus chooses the note to be played.

In an acoustic guitar, the vibration of the string, assisted by construction of the guitar body which is at least partially hollow, causes sound in the air. That sound can then be detected by a microphone and amplified. In an electric guitar, the vibration of the string is converted into an electrical signal by a transducer, and the electrical signal is amplified and then converted into sound, usually by a loudspeaker. The commonest form of transducer is an electromagnetic pickup, in which the vibration of the strings, which are typically at least partially metallic, within a magnetic field induces an electric current in a coil of wire. The amount of current generated is correlated to the sound that is produced. Electric and acoustic guitars sound very different. That is important, because a particular sound may better suit a particular style of music, or a particular musician.

A “hybrid” guitar is a guitar in which the vibration of the strings is converted into an electrical signal by a piezoelectric sensor in the bridge. The piezoelectric sensor may be the only way of producing an output, or may be used in addition to an electromagnetic electric-guitar pickup, or may be mounted on an amplified acoustic guitar. Hybrid guitars tend to produce a sound somewhere between an acoustic guitar and a conventional electric guitar.

The combination of a typical arched top guitar bridge and traditional raised tailpiece allows the length of string between the contact point on the bridge saddle and the anchor point on the tailpiece to freely ring or resonate. Each time the playing portion of a string is struck with either fingers or a plectrum, it causes not only the speaking length of the string (the points between the string nut at the lowest portion of the fingerboard and the intonation point at the bridge saddle) to vibrate and thus create a sound, but also excites the tail portion of the strings between the bridge saddle contact point and the string termination point on the tailpiece, to resonate. The resonating tail string's note is often in conflict with the sound produced by the plucked string, causing unwanted audible dissonance. Further, when using a piezo bridge saddle pickup, the pickup and amplifier are unable to reject the secondary resonance coming from the tail portion of the string. This problem is most pronounced when listening to the guitar amplified using the combination of a standard-type archtop guitar bridge with a piezo bridge pickup and typical raised tailpiece. The resonance of the tail string also interferes with using the signal from the piezo pickup to develop digital modeling sounds, because the conflicting notes from the speaking length of the string and the freely resonating tail portion of the string are sensed simultaneously by the piezo pickup element, causing the digital model to lose accuracy of pitch, attack and duration of the plucked note.

Several remedies have traditionally been used to reduce or eliminate this additional resonance. One common remedy uses one or more simple pieces of foam rubber or cloth either threaded among the strings between the bridge saddle and tailpiece or compressed between the surface of the guitar body and the underside of the tail portion of the strings. These methods have proven unreliable and the results are often inconsistent, resulting in the unwanted resonance continuing to be a problem. Cosmetically, the pieces of foam rubber or cloth material detract from the aesthetic of the instrument and are considered unacceptable by many guitarists.

There is still a need for a mute for the tail portions of the strings of a guitar that reliably and consistently damps the resonant vibrations of the tail portions, that is easy to install and remove, and that is aesthetically acceptable even in public performance.

### SUMMARY OF THE INVENTION

In one aspect, there is provided a mute for a stringed instrument comprising a formed bar of metal, plastic or other suitable material, the ends of which are folded to allow the part to wrap around the high E and low E strings in such a way as to be held firmly in place by the tension of the strings, but allowing for quick installation and removal. The inner surface of the mute is lined with a suitable material such as rubber or felt that makes firm contact with each of the 6 strings between the bridge saddle and the tailpiece, effectively stopping any of the strings between the bridge saddle and tailpiece from producing an audible sound or resonance. In this way, the mute eliminates or mitigates the problems as described above.

In another aspect, there is provided a mute for a stringed instrument, comprising a C-shaped bar of a substantially rigid first material, having a generally straight middle portion and end portions at both ends curving through more than 90° towards an underside of the bar, and having a lining of material softer than the first material on the underside of the bar and on concave sides of the curving end portions.

The bar may have a thickness and a width defining faces wider than the thickness, and one of the faces may face to the underside and be lined with the softer material.

The end portions may curve through generally 180°.

The softer material may comprise different materials on the generally straight middle portion and on the curving end portions. The material lining the middle portion may be thicker and softer than the material lining the curving end portions, and in an uncompressed state may extend beyond a straight line joining centers of curvature of the two end portions.

In use, the mute may be placed over strings of a stringed instrument, with two outermost strings received in and gripped by the curving end portions, and the softer material lining the straight middle portion of the mute pressing on strings between the two outermost strings. The mute may be dimensioned to fit the strings of a commonly available six-stringed guitar, or other common stringed instrument, and especially to fit tail portions of the strings between a bridge and a tail end attachment point of the strings.

In another aspect, there is provided a stringed instrument with a plurality of strings side by side, and the above mentioned mute placed over the strings between a bridge and a tail end anchorage of the strings, with the softer material lining the curving end portions of the mute gripping and damping two outermost strings of the plurality of strings, and with the softer material lining the straight middle portion of the mute pressing on and damping strings of the plurality of strings between the two outermost strings.

### BRIEF DESCRIPTION OF THE DRAWINGS

For the purpose of illustrating the invention, the drawings show a form of the invention which is presently preferred. However, it should be understood that this invention is not limited to the precise arrangements and instrumentalities shown in the drawings.

FIG. 1 is a schematic perspective view of a guitar with a mute according to the present invention shown attached to the guitar strings.

FIG. 2 is a perspective view of a mute according to the present invention.

FIG. 3A is a top view of a bar forming part of the mute of FIG. 2.

FIG. 3B is a front view of the bar of FIG. 3A.

FIG. 3C is a bottom view of the lining segments used in the mute of FIG. 2.

FIG. 3D is a front view of the lining segments of FIG. 3C.

### DETAILED DESCRIPTION

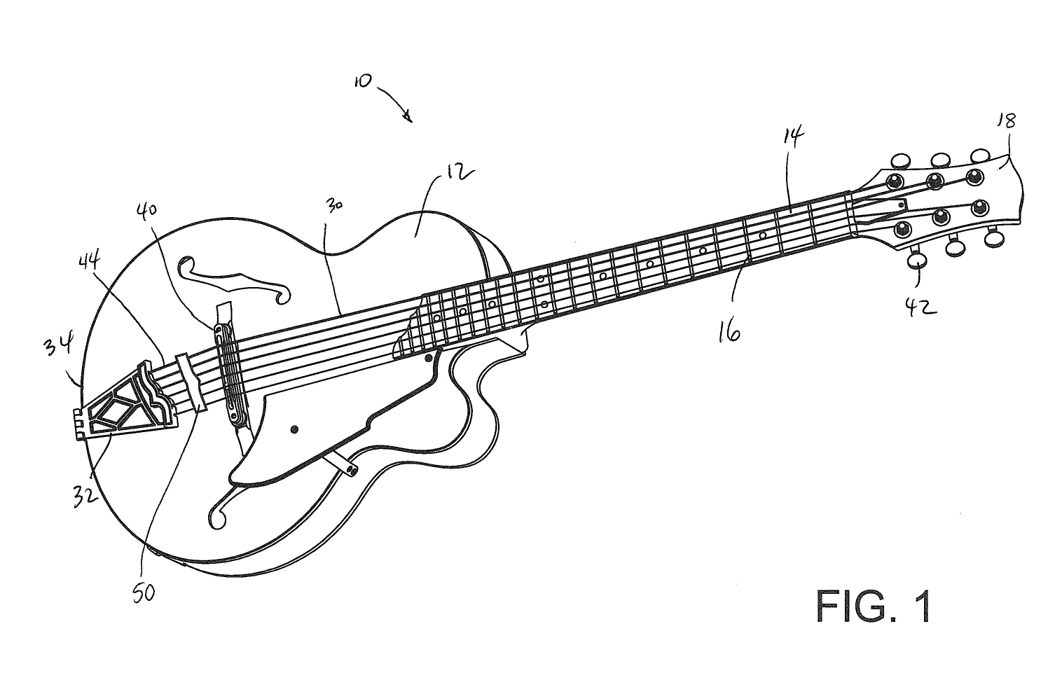

Referring to the drawings, and initially to FIG. 1, a guitar indicated generally by the reference numeral 10 has a body 12, a neck 14 with frets 16, and a head 18. A typical arched top guitar body consists basically of a top either carved from solid wood or pressed from laminated wood material to have a pronounced raised center section shaped similarly to a violin top, minimally internally braced, to resist downward pressure exerted by tensioned strings on a bridge mounted on the top, an arched, carved or flat back, and curved sides joining the aforementioned top and back.

Several strings 30 are attached to an anchorage 32 near a tail end 34 of the body 12, and extend over a bridge indicated generally by the reference numeral 40 and up the neck 14 to the head 18, where they are attached to rotatable pegs 42. The tension of each string 30 can be adjusted in the usual way by rotating the respective peg 42 to wind string onto or off the peg, thereby increasing and decreasing tension, respectively.

The guitar 10 may be a hybrid guitar, in which the bridge 40 includes a piezoelectric pickup that is responsive to vibration in the strings 30 and, to a lesser extent, to vibration of the guitar body. Such piezoelectric pickup bridges 40 are well known and, in the interests of conciseness, will not be further described.

In use, the guitar 10 is played by pressing one or more of the strings 30 against a fret on the neck 14, and plucking or strumming the portion of the string or strings between the selected fret or frets and the bridge, producing from each string a vibration, and therefore a note of a desired pitch. The vibration tends to travel to other parts of the guitar 10, producing additional resonances. In particular, tail portions 44 of the strings 30 between the bridge 40 and the anchorage 32 may start to vibrate, at a pitch that cannot be controlled and may clash with the notes being played. A piezoelectric pickup bridge 40 is positioned such that it can pick up the resonance of the tail portions 44.

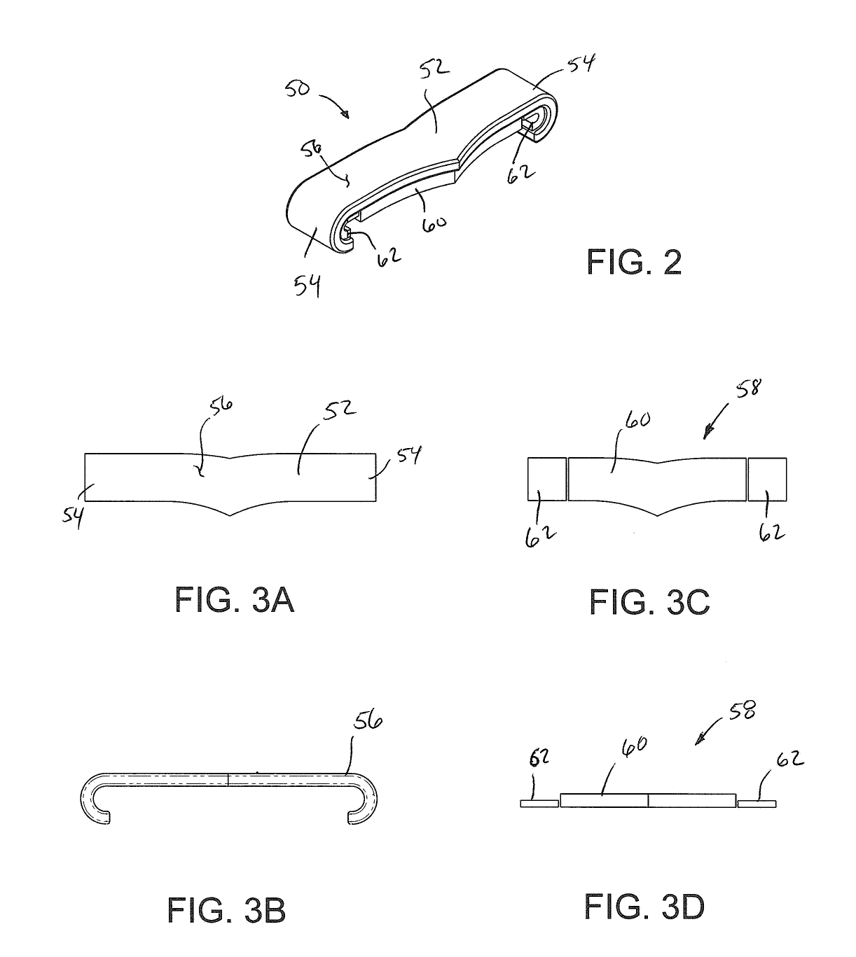

Referring now also to FIGS. 2 and 3A-3D, a mute indicated generally by the reference numeral 50 is placed over the string tail portions 44 to suppress the resonance of those portions. The mute 50 is generally C-shaped, with a flat, straight middle portion 52 and two end portions 54 curving through approximately a semicircle.

As best seen in FIGS. 3A and 3B, the mute 50 comprises a bar 56 of fairly rigid material, such as metal or hard plastic, wider than it is thick. The curving end portions 54 curve in the thickness direction (toward the bottom of the bar 56) around axes that extent parallel to each other and to the width direction of the bar. As shown in the drawings, the curving end portions are preferably substantially circular semi-cylindrical. Depending on the material of the bar 56, it may be made by bending a flat blank, may be cast in its final shape, may be formed as an extrusion, or may be made by any other appropriate method. The mute 50 shown in the drawings is of aluminum, but it is believed that other suitable metals or plastics made to similar dimensions will also work.

Referring now to FIGS. 3C and 3D, the bottom and concave inner ends of the bar 56 include a lining of softer material indicated generally by the reference numeral 58. In the embodiment, the lining 58 consists of pieces or segments of preferably different materials, which for clarity are shown in FIGS. 3C and 3D laid out in a flat pattern and side by side. A middle lining piece 60 consists, preferably of a compressible material, and is glued or otherwise secured to the bottom surface of the bar 56 in the straight middle portion 52 of the mute 50. End lining pieces 62 are glued or otherwise secured to the bar 56 in the curving end portions 54. The material of the middle lining piece can be foam, felt or rubber. In the embodiment, the end lining pieces 62 are of a denser material than the middle lining piece 60, which in this embodiment is preferably rubber, so that they will not wear out from the friction of attaching and removing the mute 50. The end sections 54, 62 must grip the outermost strings (E strings on a typical guitar) to hold the mute 50 in place while also damping the vibration of those strings. A relatively tough material is preferred for the end lining pieces 62 that would fulfill all the criteria and wear well over time and use. The material of the middle lining piece 60 can be of less density than the end lining pieces 62, as long as the less dense material will sufficiently mute the four inside strings.

In use, the mute 50 is put over the string tail portions 44 by hooking one curving end 54 over one of the outermost strings, and squeezing the two outermost strings together until the other curving end 54 can pass the other outermost string. The two outermost strings are then released, and press against the rubber end linings 62, which both holds the mute 50 in position and damps any vibration of the two outermost strings. The felt middle lining 60 will then be pressing on the remaining strings, damping their vibration. Applicants have found that with suitable dimensions the outside E strings tend to “nestle” in the curved area 54, 62 of the ends of the mute. String tension pushes the outside E strings into the rubber lining pieces 62 to hold them in place. The mute 50 may be easily removed by reversing the process by which it was installed.

As an example of suitable dimensions for an ordinary six-stringed guitar, the bar 56 may be formed from an aluminum blank 73.5 mm long, 12 mm wide, and 2.5 mm thick, and the ends may be rolled with an interior radius of 2.5 mm and an exterior radius of 5 mm, to form a component with an overall length of 58.5 mm and an opening of 47 mm between the tips of the curving ends. The linings 60 and 62 may be 10 mm wide. The rubber end linings 62 may be 1.6 mm thick and 9 mm long, and the felt middle lining may be 3.2 mm thick and of a length chosen to fit snugly between the two rubber linings. The precise dimensions mentioned were determined to fit a specific guitar bridge and tailpiece. However, the general size of the mute 50, and the softness of the linings 60, 62 should make a mute 50 of approximately these dimensions adaptable to nearly any bridge/tailpiece combination typically found on an arched top guitar. In addition, many guitars have the string tail ends converging, so that they are closer together at the anchorage than they are at the bridge. The mute can then be easily slid along the length of the strings between the bridge and anchorage point until it fits snugly, which further increases the range of guitars for which a single size of mute 50 is satisfactory.

Although not shown, it is contemplated that the top surface of the bar 56 can have ornamentation added to provide visual aesthetics. The ornamentation can be on the bar itself or on a secondary item that is attached to the top surface of the bar.

Although an example of a six-stringed guitar is shown in the drawings, those skilled in the art will understand how the teachings of the present application may be applied to other stringed musical instruments.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

1. A mute for a stringed musical instrument, comprising:
a generally C-shaped bar of a first material having a substantially straight middle portion with two ends and an underside and at each end of the middle portion an end portion curving to the underside through more than 90°; and
a lining softer than the first material on the underside of the middle portions of the bar and insides of the curving end portions.

2. The mute according to claim 1, wherein the middle portion of the bar has a length from end to end, a width less than the length, and a thickness towards and away from the underside less than the thickness, and wherein the curving end portions are part-cylindrical.

3. The mute according to claim 1, wherein the lining comprises a middle lining on the underside of the middle portions of the bar and end linings on the insides of the curving end portions.

4. The mute according to claim 3, wherein the middle lining is thicker and softer than the end linings.

5. The mute according to claim 4, wherein the middle lining extends beyond an imaginary straight line joining centers of curvature of the end portions.

6. The mute according to claim 4, wherein the middle lining is of felt and the end linings are of rubber.

7. A musical instrument comprising a plurality of strings side by side, and a mute according to claim 1 spanning the plurality of strings, with the lining inside the curved end portions engaging outermost ones of the plurality of strings, and with the lining on the underside of the middle portion engaging ones of the plurality of strings between the outermost ones.

8. The musical instrument according to claim 7, wherein the strings extend over a bridge between a sounding portion of the strings and a tail portion, the tail portion of the strings being attached to an anchor, and the mute is between the bridge and the anchor.

9. A mute for a stringed musical instrument, comprising:
a generally C-shaped bar of a first material having a substantially straight middle portion with two ends and an underside and at each end of the middle portion an end portion formed integral with the middle portion and having a substantially semi-circular curvature, each end portion curving toward the underside; and
a lining made from at least one material that is softer than the first material on the underside of the middle portions of the bar and insides of the curving end portions, the softer material adapted to damp or mute vibrations of musical strings.

10. The mute according to claim 9, wherein the lining comprises a middle lining on the underside of the middle portion of the bar and end linings on the insides of the curving end portions.

11. The mute according to claim 10, wherein the middle lining is thicker and softer than the end linings.

12. The mute according to claim 10, wherein the middle lining is of felt and the end linings are of rubber.

13. A combination of a mute according to claim 9 and a stringed instrument, the stringed instrument having an anchorage, a tail end and a plurality of strings extending between the anchorage and the tail end, and wherein the mute is attached to the strings between the anchorage and the tail end.
